(19) United States
(12) Patent Application Publication
(10) Pub. No.: US 2002/0038365 A1
(43) Pub. Date: Mar. 28, 2002

(54) Method and system for real-time analyzing and processing data over the internet

(75) Inventor: Chia-Wen Yeh, Taipei Hsien (TW)

Correspondence Address: ROTHWELL, FIGG, ERNST & MANBECK, P.C., 555 13TH STREET, N.W., SUITE 701, EAST TOWER, WASHINGTON, DC, 20004, US

(73) Assignee: Mythink Technology Co,. Ltd., Taipei Hsien (TW)

(21) Appl. No.: 09/931,077

(22) Filed: Aug. 17, 2001

(30) Foreign Application Priority Data
Sep. 25, 2000 (TW) 89119707

(51) Int. Cl. G06F 15/16

(52) U.S. Cl. 709/224; 709/218; 709/219

(57) ABSTRACT

A method and a system for real-time analyzing and processing data over the internet are proposed, that can real-time analyze and process data relating to a user's browsing behavior in terms of the contents of a web site browsed by the user, user's accounts used in other web sites and personal information such as e-mail account or identification number, recorded by the web site browsed by the user, so as to display in a browser of the user's computer device a web site different from the web site browsed by the user in response to the analyzed and processed data. In this case, while the user's browser is linked to the foregoing system through the internet, the system can be real-time responsive to the user's browsing behavior for providing the user with different web sites preferred by the user.

### FIELD OF THE INVENTION

The present invention relates to methods and systems for analyzing and processing data, and more particularly, to a method and system for real-time analyzing and processing data over the internet for users to interact with web sites.

### BACKGROUND OF THE INVENTION

In general, entry-level web sites, such as Yahoo, provide the function of searching and browsing homepages of other web sites linked to the entry-level web sites. However, the prior art entry-level web sites and the web sites linked thereto can only record TCP/IP of a user, personal information of the user input in the web site and browsing time spent in the web site, but can not record and analyze the browsing behavior of a user who interacts therewith, such as the contents of the web sites browsed by the user, user's account of other web sites used by the user, personal information such as e-mail account or identification number. Thus, the prior art web sites do not provide the user with the function of displaying in the user's computer device the homepage of a certain web site that the user may find it interested or necessary.

As conventional web sites can only record data such as the TCP/IP of the user, the personal information input in the web site by the user and the browsing time spent in the web sites, they are unable to analyze and process the user's browsing behavior in terms of the data obtained from the web site browsed by the user, for allowing the homepage of a web site preferred by the user to display in the browser of the user's computer device in response to the analytical and processing results. Therefore, it is desired to have a novel method and system for processing and analyzing data over the internet that can real-time analyze and process data relating to a user's browsing behavior recorded by a web site browsed by the user, so as to display in the browser of the user's computer device the homepage of a web site different from the web site browsed by the user responsive to the analytical and processing results of the user's browsing behavior.

### SUMMARY OF THE INVENTION

A primary objective of the present invention is to provide a method and a system for real-time analyzing and processing data over the internet, that can real-time analyze and process data relating to a user's browsing behavior, such as the contents of a web site browsed by the user, user's account of other web sites used by the user, personal information such as e-mail account or identification number (ID), recorded by the web site browsed by the user, so as to display in the browser of the user's computer device the homepage of a web site different from the web site browsed by the user responsive to the analytical and processing results of the user's browsing behavior.

In accordance with the foregoing and other objectives, a novel method and system for real-time analyzing and processing data over the internet is proposed in the present invention. The system for real-time analyzing and processing data comprises a web site server, a data classifying-processing server, a data controlling-processing server, a database, a data statistically-analyzing server, a data managing-processing module and a data managing interface.

In the method for using the system for real-time analyzing and processing data over the internet, first, a browser of the user's computer device is linked to the web site server of the system through the internet, and subsequently the web site server displays a homepage of the web site server in the browser for the user and records data relating to the user's information in terms of personal information input by the user such as e-mail account or ID, user's browsing behavior, content of a web site browsed by the user, while the recorded data are transmitted to the data classifying-processing server of the system. Then, the data classifying-processing server classifies and processes the data from the web site server. The classified and processed data by the data classifying-processing server are integrally constructed, and transmitted to the database for storage. Subsequently, the data statistically-analyzing server statistically analyzes, analytically compares and re-constructs the integrally-constructed data stored in the database, while the analyzed data are transferred to the data managing-processing module for data management and controlling. Furthermore, the data managing-processing module manages the data managing interface in a manner that the data managing-processing module is correspondingly responsive to different requests from the data managing interface. Moreover, the data managing-processing module manages and controls a data controlling-processing server in response to the analyzed data from the data statistically-analyzing server, wherein the management and controlling for the data controlling-processing server can be modified by the data managing-processing module as requested by the data managing interface. Hereafter, the data controlling-processing server, managed and controlled by the data managing-processing module, modifies parameters relating to the user's information; while the modified parameters are transmitted to the web site server. Subsequently, the web site server in response to the parameters displays the homepage of the web site server or a homepage of a different web site in the browser for the user.

### BRIEF DESCRIPTION OF THE DRAWINGS

The present invention may best be understood through the following description with reference to the accompanying drawings, in which:

FIG. 1 is a block diagram showing the connection of the system for real-time analyzing and processing data of the invention to a browser and homepages of web sites;

FIG. 2 is a block diagram showing the basic configuration of the system for real-time analyzing and processing data of the invention;

FIG. 3 is a schematic diagram showing the steps involved in provision of web sites for a user by the system for real-time analyzing and processing data of the invention according to the user's access right and behavior; and

FIG. 4 is a schematic diagram showing the detailed steps involved in provision of web sites for a user by the system for real-time analyzing and processing data of the invention according to the user's access right and behavior.

### DETAILED DESCRIPTION OF THE PREFERRED EMBODIMENT

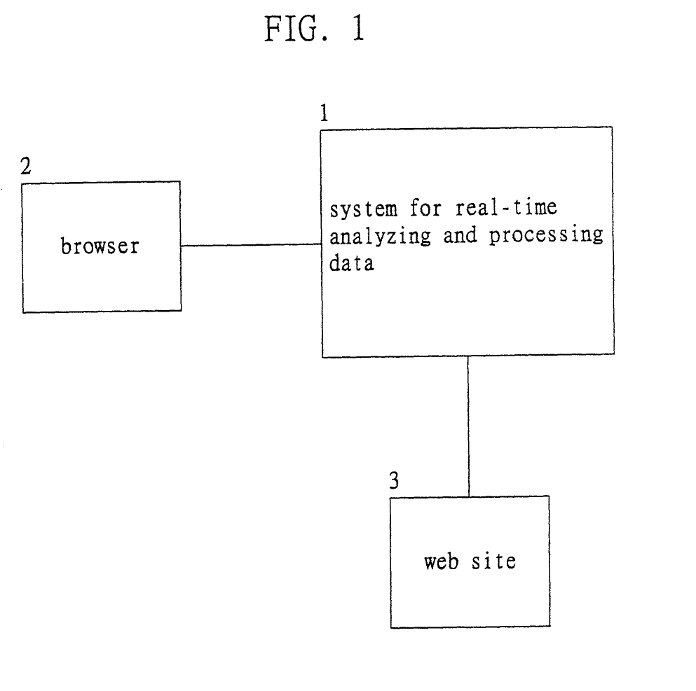

Illustrated in FIG. 1 is a block diagram showing the connection of the system for real-time analyzing and processing data of the invention to a browser and homepages of web sites. As shown in the drawing, as the browser 2 of a user's computer device is linked to the system for real-time analyzing and processing data 1 through the internet, the system 1 firstly identifies the user according to ID and password input thereto through the browser 2 for determining the system access right of the user, and subsequently displays a homepage of the system 1 and/or a different web site 3 in the browser 2 in response to the user's access right. In the case of no ID and password being input, the system 1 then displays a default homepage in the browser 2. In general, the system 1 is correspondingly responsive to the user's behavior in browsing the homepage of the system 1 or the web site 3 no matter of availability of the ID and password. Moreover, the system for real-time analyzing and processing data 1 can further record and collect data relating to the user's browsing behavior for analyzing and processing such as the contents of the web site 3 browsed by the user, user's accounts of other web sites used by the user, personal information such as e-mail account or identification number, so as to display in the browser 2 the homepage of a web site different from the web site browsed by the user in response to the analyzed and processed results.

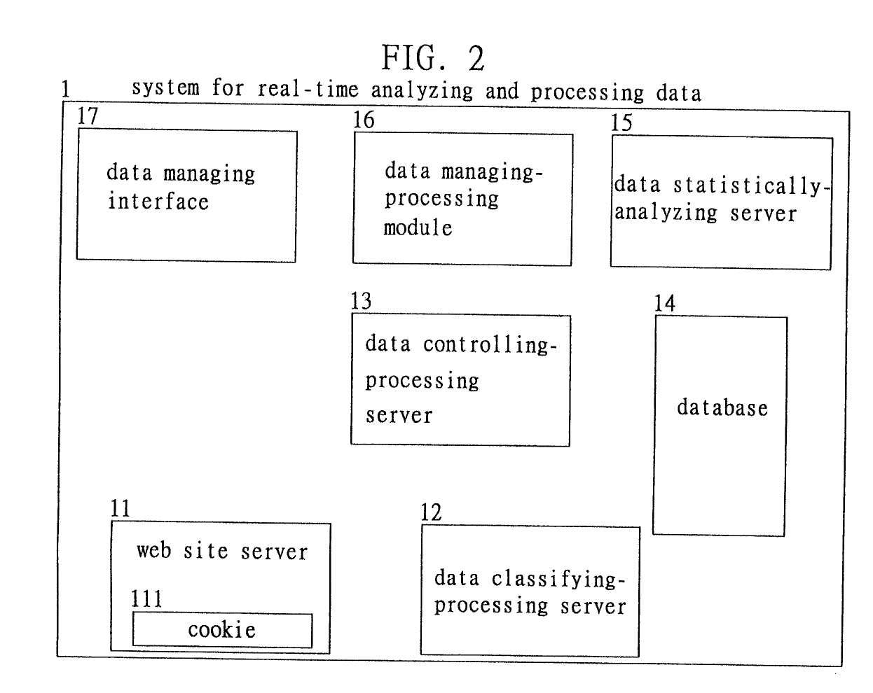

FIG. 2 illustrates a block diagram showing the basic configuration of the system for real-time analyzing and processing data of the invention. As shown, the system for real-time analyzing and processing data I includes a web site server 11, a data classifying-processing server 12, a data controlling-processing server 13, a database 14, a data statistically-analyzing server 15, a data managing-processing module 16 and a data managing interface 17.

The web site server 11 stores ID and password of a user used in the system for real-time analyzing and processing data 1. As a browser of the user's computer device is linked to the system 1 through the internet, the user can access a homepage (not shown) of the web site server 11 displayed in the browser. The web site server 11 then identifies the user according to the ID and password input thereto for determining the system access right of the user, and subsequently provides the user with the homepage of the web site server 11 and/or a different web site displayed in the browser in response to the user's access right. If no ID and password are input, the web site server 11 then displays a default homepage in the browser. Moreover, in cooperation with the data classifying-processing server 12, the data controlling-processing server 13, the database 14, the data statistically-analyzing server 15 and the data managing-processing module 16, the displaying of the web site homepages in the browser can be realized by the web site server 11 based on the user's ID together with the user's browsing behavior in a previous or new web site browsed by the user.

Furthermore, the web site server 11 records data input thereto through the browser by the user, e.g. personal information for age, sex, education and profession, as well as records data relating to the user's browsing behavior in the use of a cookie 111, in terms of the contents of the web site browsed by the user, user's accounts of different web sites used by the user, personal information such as e-mail account or identification number, for transmitting the data to the data classifying-processing server 12. Additionally, in accordance with parameters relating to the user's access right, the displayed web sites and the browsing behavior generated from the data controlling-processing 13, the web site server 11 displays corresponding contents of the homepage of the web site server 11 or the different web site in the browser.

The data classifying-processing server 12 classifies and processes the data relating to the user's personal information and browsing behavior from the web site server 11 in the use of an analyzing rule and a behavior recording module pre-constructed in the data classifying-processing server 12. The classified and processed data are integrally constructed, which are then transmitted to the database 14.

The database 14 stores the integrally-constructed data from the data classifying-processing server 12, data analyzed by the data statistically-analyzing server 15 and the parameters modified by the data controlling-processing server 13.

The data controlling-processing server 13 includes a real-time output mode, a precise comparing system, a general comparing system and a behavior re-recording rule. The data controlling-processing server 13 can be managed and controlled by the data managing-processing module 16 according to analyzed data transmitted from the data statistically-analyzing server 15, so as to modify the parameters relating to the user's access right, the displayed web sites and the browsing behavior. The modified parameters are then transmitted to the web site server 11 and the database 14.

The data statistically-analyzing server 15 provides functions of data storing application, different data analyzing module comparison, on-line determining system and customizing interface system, so as to statistically analyze, analytically compare and re-construct the integrally-constructed data from the data classifying-processing server 12 stored in the database 14, while the analyzed data are then transferred to the database 14 for storage and to the data managing-processing module 16 for data management and controlling.

The data managing-processing module 16 functions in target analyzing system, general knowledge determination and self-learning analysis. Upon receipt of the analyzed data from the data statistically-analyzing server 15, the data managing-processing module 16 accordingly manages and controls the data controlling-processing server 13. Further, the data managing-processing module 16 possesses a detachably managing mode for managing and controlling the analyzed data from the data statistically-analyzing server 15 in the use of a leveled managing interface, as well as an on-line real-time determining subsystem for examining the analyzed data from the data statistically-analyzing server 15, while the examined data are transmitted to the data controlling-processing server 13. Moreover, as receiving a request from the data managing interface 17 for adjusting the data processing, the data managing-processing module 16 accordingly modifies the management and controlling for the data controlling-process server 13. In addition, the data managing interface 17 can be managed by the data managing-processing module 16 in a manner that the data managing-processing module 16 is correspondingly responsive to different requests from the data managing interface 17.

As a result, if necessary, a statistically analytical report for the user's behavior can be generated by the data managing-processing module 16 in response to a request from the data managing interface 17, and similarly, the condition of data processing can be adjusted in an effort of the data managing-processing module 16 as requested by the data managing interface 17.

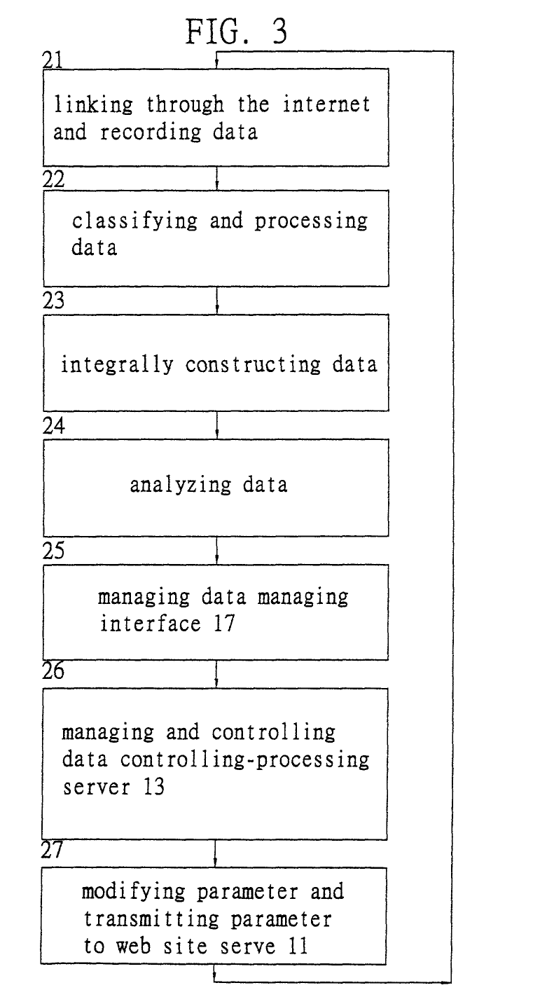

FIG. 3 illustrates the steps involved in provision of web sites for a user by the system for real-time analyzing and processing data of the invention according to the user's access right and behavior. As shown, first in step 21, a browser of the user's computer device is linked to a web site server 11 of the system for real-time analyzing and processing data 1 through the internet, and subsequently the web site server 11 displays a homepage of the web site server 11 in the browser for the user and records data relating to the user's information in terms of personal information input by the user such as e-mail account or ID, user's browsing behavior, content of a web site browsed by the user, while the recorded data are transmitted to a data classifying-processing server 12 of the system 1. It then proceeds to step 22.

In step 22, the data classifying-processing server 12 classifies and processes the data from the web site server 11. Then it proceeds to step 23.

In step 23, the classified and processed data by the data classifying-processing server 12 are integrally constructed, and then transmitted to a database 14. Then it moves on to step 24.

In step 24, a data statistically-analyzing server 15 statistically analyzes, analytically compares and re-constructs the integrally-constructed data from the data classifying-processing server 12 stored in the database 14, and analyses data relating to the user's browsing behavior and the contents of the web sites browsed by the user, while the analyzed data are transferred to a data managing-processing module 16 for data management and controlling. It then moves on to step 25.

In step 25, the data managing interface 17 can be managed by the data managing-processing module 16 in a manner that the data managing-processing module 16 is correspondingly responsive to different requests from the data managing interface 17. It proceeds next to step 26.

In step 26, the data managing-processing module 16 manages and controls a data controlling-processing server 13 in response to the analyzed data from the data statistically-analyzing server 15. Moreover, the management and controlling for the data controlling-processing server 13 can be modified by the data managing-processing module 16 as requested by a data managing interface 17. It proceeds next to step 27.

In step 27, the data controlling-processing server 13, managed and controlled by the data managing-processing module 16, modifies parameters relating to the user's access right, the displayed contents of the web sites and the browsing behavior; while the modified parameters are transmitted to the web site server 11. Subsequently, the web site server 11 in response to the parameters displays the homepage of the web site server 11 or a different web site in the browser 2 for the user. It then returns to step 21.

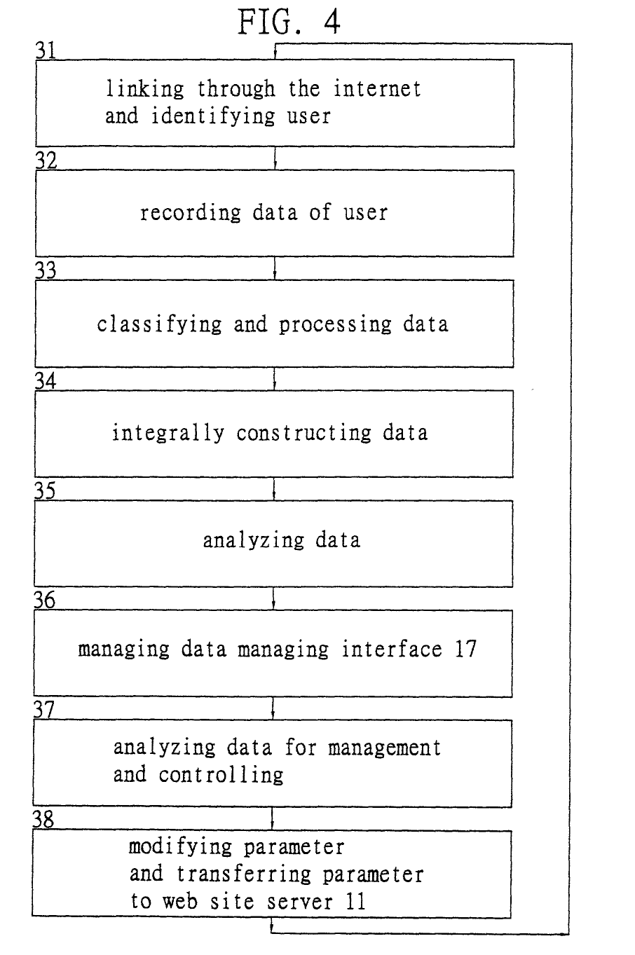

The system for real-time analyzing and processing data 1 of the invention used for providing web sites for a user according to the user's access right and behavior is further detailed as illustrated in FIG. 4. As shown in the drawing, first in step 31, with linkage of a browser 2 of the user's computer device to a web site server 11 of the system 1 through the internet, the user can access a homepage of the web site server 11 displayed in the browser 2, and input ID and password to the homepage. The web site server 11 then identifies the user according to the input ID and password for determining the system access right for the user, so as to provide and display in the browser 2 a homepage of the web site server 11 and/or a different web site in response to the user's access right. In the case of no ID and password being available, the web site server 11 then displays a default homepage in the browser 2. Moreover, in cooperation with a data classifying-processing server 12, a data controlling-processing server 13, a database 14, a data statistically-analyzing server 15 and a data managing-processing module 16 of the system for real-time analyzing and processing data 1, the displaying of the web site homepages in the browser 2 can be realized by the web site server 11 based on the user's ID together with the user's browsing behavior in previous or new web sites browsed by the user. It then proceeds to step 32.

In step 32, the web site server 11 records data relating to personal information input thereto through the browser 2 by the user, and to the user's browsing behavior in the use of a cookie 111, in terms of the contents of the web sites browsed by the user, user's accounts of different web sites used by the user, personal information such as e-mail account or identification number, for transmitting the data to the data classifying-processing server 12 for data classification and processing. Then it proceeds to step 33.

In step 33, the data classifying-processing server 12 classifies and processes the data transmitted from the web site server 1 1 in the use of an analyzing rule and a behavior recording module, which are pre-constructed in the data classifying-processing server 12. Then it moves on to step 34.

In step 34, the classified and processed data by the data classifying-processing server 12 are integrally constructed, and then transmitted to a database 14 for storage. It then moves on to step 35.

In step 35, the data statistically-analyzing server 15 statistically analyzes, analytically compares and re-constructs the integrally-constructed data from the data classifying-processing server 12 stored in the database 14, in operation of behavior statistical analysis, data storing application, different data analyzing module comparison, on-line determination and customizing interface. The analyzed data are transferred to the database 14 for storage and to the data managing-processing module 16 for data management and controlling. It proceeds next to step 36.

In step 36, the data managing-processing module 16 manages the data managing interface 17 in a manner that the data managing-processing module 16 is correspondingly responsive to different requests from the data managing interface 17. In addition, if necessary, a statistically analytical report for the user's behavior can be generated by the data managing-processing module 16 in response to a request from the data managing interface 17, and similarly, the condition of data processing can be adjusted in an effort of the data managing-processing module 16 as requested by the data managing interface 17. It proceeds next to step 37.

In step 37, the data managing-processing module 16 manages and controls the data controlling-processing server 13 in response to the analyzed data from the data statistically-analyzing server 15, in which the management and controlling can be modified by the data managing-processing module 16 according to a request from a data managing interface 17. It then moves on to step 38.

In step 38, the data controlling-processing server 13, managed and controlled by the data managing-processing module 16, modifies parameters relating to the user's access right, the displayed contents of the web sites and the browsing behavior, in the use of a real-time output mode, a precise comparing system, a general comparing system and a behavior re-recording rule pre-constructed in the data controlling-processing server 13. The modified parameters are transmitted to the web site server 11, for allowing the web site server 11 to display the homepage of the web site server or a different web site in the browser for the user in response to the parameters. It then returns to step 31.

In conclusion, the method and system for real-time analyzing and processing data over the internet of the invention can real-time analyze and process data relating to a user's browsing behavior in terms of the contents of a web site browsed by the user, user's accounts used in other web sites and personal information such as e-mail account or identification number, recorded by the web site browsed by the user, so as to display in a browser of the user's computer device a web site different from the web site browsed by the user in response to the analyzed and processed data. In this case, while the user's browser is linked to the foregoing system through the internet, the system can be real-time responsive to the user's browsing behavior for providing the user with different web sites preferred by the user.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for real-time analyzing and processing data over the internet, which is used in a system for real-time analyzing and processing data having a web site server, a data classifying-processing server, a data controlling-processing server, a database, a data statistically-analyzing server, a data managing-processing module and a data managing interface, comprising the steps of:
(1) linking a browser of a user's computer device to the web site server of the system for real-time analyzing and processing data through the internet, and via the web site server displaying a homepage of the web site server in the browser and recording data relating to the user's information, wherein the recorded data are transmitted to the data classifying-processing server;
(2) via the data classifying-processing server classifying and processing the data from the web site server;
(3) via the data controlling-processing server integrally constructing the classified and processed data from the step (2), and transmitting the integrally-constructed data to the database for storage;
(4) via the data statistically-analyzing server statistically analyzing, analytically comparing and re-constructing the integrally-constructed data in the database from the data controlling-processing server, and transmitting the analyzed data to the data managing-processing module;
(5) via the data managing-processing module managing the data managing interface in a manner that the data managing-processing module is correspondingly responsive to different requests from the data managing interface;
(6) via the data managing-processing module managing and controlling the data controlling-processing server in response to the analyzed data from the data statistically-analyzing server, wherein the management and controlling is modified by the data managing-processing module according to a request from the data managing interface; and
(7) via the data controlling-processing server modifying parameters relating to the user's information, and transmitting the modified parameters to the web site server for displaying the homepage of the web site server or a homepage of a different web site for the user in response to the parameters.

2. The method of claim 1, wherein in the step (1), the web site server displays in the browser the homepage thereof in content responsive to system access right of the user identified according to an identification number (ID) and a password input by the user to the web site server through the browser, while in the case of no ID and password being input, the web site server displays a default homepage in the browser.

3. The method of claim 2, wherein the displaying of the homepage of the web site server or the different web site is implemented by the web site server further responsive to the user's ID as well as user's behavior recorded in a previous web site having the user's ID or a new web site browsed by the user, in cooperation with the data classifying-processing server, the data controlling-processing server, the database, the data statistically-analyzing server and the data managing-processing module.

4. The method of claim 1, wherein the user's information recorded by the web site server includes personal information input by the user, user's browsing behavior, content of a web site browsed by the user.

5. The method of claim 4, wherein the personal information includes an e-mail account or an identification number.

6. The method of claim 1, wherein in the step (2), the data classifying-processing server classifies and processes the data in the use of an analyzing rule and a behavior recording rule pre-constructed in the data classifying-processing server.

7. The method of claim 1, wherein in the step (4), the data statistically-analyzing server further provides functions of analytical statistics, data storing application, different data analytical comparison, on-line determination and customizing interface for analyzing the data.

8. The method of claim 1, wherein the data managing-processing module further generates a statistically analytical report for the user's information in response to a request from the data managing interface, as well as, adjusts condition of processing the data as requested by the data managing interface.

9. The method of claim 1, wherein in the step (7), the data controlling-processing server modifies the parameters in the use of a real-time output mode, a precise comparing system, a general comparing system and a behavior re-recording rule pre-constructed in the data controlling-processing server.

10. A system for real-time analyzing and processing data over the internet, comprising:
a web site server for linking a browser of a user's computer device thereto through the internet, and for displaying a homepage thereof in the browser and recording data relating to the user's information;
a data classifying-processing server for classifying and processing the recorded data in the web site server;
a data controlling-processing server for integrally constructing the classified and processed data from the data classifying-processing server and transmitting the integrally-constructed data to a database for storage;
a data statistically-analyzing server for statistically analyzing, analytically comparing and re-constructing the integrally-constructed data in the database;
a data managing-processing module for receiving the analyzed data from the data statistically-analyzing server, and for managing and controlling the data controlling-processing server for modifying parameters relating to the user's information, wherein the modified parameters are transmitted to the web site server for displaying in the browser for the user the homepage of the web site server or a homepage of a different web site in response to the parameters; and
a data managing interface managed by the data managing-processing module in a manner that the data managing-processing module is correspondingly responsive to different requests from the data managing interface, wherein the management and controlling for the data controlling-processing server are modified by the data managing-processing module as requested by the data managing interface.

11. The system of claim 10, wherein the web site server displays in the browser the homepage thereof in content responsive to system access right of the user identified according to an identification number (ID) and a password input by the user to the web site server through the browser, while in the case of no ID and password being input, the web site server displays a default homepage in the browser.

12. The system of claim 11, wherein the displaying of the homepage of the web site server or the different web site is implemented by the web site server further responsive to the user's ID as well as user's behavior recorded in a previous web site having the user's ID or a new web site browsed by the user, in cooperation with the data classifying-processing server, the data controlling-processing server, the database, the data statistically-analyzing server and the data managing-processing module.

13. The system of claim 10, wherein the user's information recorded by the web site server includes personal information input by the user, user's browsing behavior, content of a web site browsed by the user.

14. The system of claim 13, wherein the personal information includes an e-mail account or an identification number.

15. The system of claim 10, wherein the data classifying-processing server classifies and processes the data in the use of an analyzing rule and a behavior recording rule pre-constructed in the data classifying-processing server.

16. The system of claim 10, wherein the data statistically-analyzing server further provides functions of analytical statistics, data storing application, different data analytical comparison, on-line determination and customizing interface for analyzing the data.

17. The system of claim 10, wherein the data managing-processing module further generates a statistically analytical report for the user's information in response to a request from the data managing interface, as well as, adjusts condition of processing the data as requested by the data managing interface.

18. The system of claim 10, wherein the data controlling-processing server modifies the parameters in the use of a real-time output mode, a precise comparing system, a general comparing system and a behavior re-recording rule pre-constructed in the data controlling-processing server.
